(19) United States
(12) Patent Application Publication
(10) Pub. No.: US 2012/0137849 A1
(43) Pub. Date: Jun. 7, 2012

(54) APPARATUS FOR CUTTING HIDES AND THE LIKE

(75) Inventor: Stefano Zorzolo, Vigevano (IT)

(73) Assignee: COMELZ S.P.A., Vigevano (IT)

(21) Appl. No.: 13/389,633

(22) PCT Filed: Jul. 20, 2010
(86) PCT No.: PCT/EP10/60508

§ 371 Date: Feb. 9, 2012

(30) Foreign Application Priority Data
Sep. 4, 2009 (IT) MI2009A001535

(51) Int. Cl. B26F 1/38; C14B 5/00; B26D 5/20

(52) U.S. Cl. 83/734; 83/829; 83/401

(57) ABSTRACT

A cutting apparatus, particularly for hides, comprising a worktable, which defines a cutting area, surmounted by at least one movable transverse bridge, at least one cutting head being provided in order to perform cutting operations, at least one cutting head being supported in a cantilever fashion at a first end of an arm that is adapted to be moved, at a second end thereof, along the movable bridge, transversely with respect to guides for the sliding of the movable bridge, which are arranged laterally with respect to the worktable.

### TECHNICAL FIELD

The present invention relates to an apparatus for cutting hides and the like. More particularly, the invention relates to an apparatus for cutting hides, with or without a conveyor belt.

### BACKGROUND ART

As is known, apparatuses for cutting hides and the like are known which have a worktable on which at least one cutting head, adapted to cut the hide arranged on the worktable, moves in different manners that will be shown hereinafter.

Currently there are cutting systems with or without a conveyor belt with a single or double cutting head, with two different architectures for the movement of the cutting heads.

According to a first technical solution, systems for cutting with or without a conveyor belt and with a single or double cutting head are known which have the advantage of having a head movement system that is constructively simple and inexpensive (similarly to what occurs in the field of plotters), wherein the head slides along a transverse axis X (with respect to the advancement direction of the conveyor belt) along a bridge that surmounts the cutting area or worktable along its width, and moves in a longitudinal direction Y (with respect to the belt) along two systems of guides which are arranged along the mutually opposite longitudinal sides of the cutting area.

The system described above is efficient if the operator, located at one end of the conveyor belt, does not have to work in close contact with the cutting unit, which is instead useful in order to keep the cutting operations under control or if the operator, besides performing the operations for placing the hide (by projection of the outlines to be cut), also needs to have access, from the same working position, to the already-cut hide pieces, without hindering the cutting operations or interrupting them to move the conveyor belt.

To do this, it is in fact necessary to overlap (even just partially) the placement and cutting areas (which are in sequence along the belt), and therefore the presence of the transverse bridge (along its entire length) in the common area would limit severely the view of the operator and the projection field for placement.

The systems described above are known as movable transverse bridge systems.

Systems with a fixed transverse bridge are also known which are cutting systems with a conveyor belt and a double cutting head in which each head moves in a longitudinal direction Y along an arm which is oriented longitudinally and slides in a transverse direction X along a fixed bridge that surmounts the cutting area in terms of width. By placing the cutting unit in a position that is cantilevered with respect to the fixed transverse bridge, by means of the longitudinal arm, the interference of visual obstacles in the common placement/cutting area is thus limited to the width of the cutting head.

However, the presence of a fixed transverse bridge on which carriages slide which support the arms, in a fully cantilevered manner, requires an adequate rigidity of the arms with respect to the maximum cantilever, which, in the case of long strokes, can even require the use of a telescopic cantilever system.

In other implementations, rigidity is instead ensured by a double system of guides of the fixed transverse bridge, which supports the arms close to the two ends, while the cantilevered arrangement of the cutting head, which is more limited, is obtained starting from the carriage of the arms.

In both implementations with transverse bridge described above, moreover, the fixed transverse bridge must be arranged at such a height from the worktable or cutting area as to allow the passage below it of the cutting head in its height. This entails an increase in the distance of the guides from the worktable which affects precision and flexural strength in relation to the cutting loads generated on said worktable.

Moreover, the architecture with fixed transverse bridge is certainly more onerous than the movable bridge architecture, though having the advantage of being able to move multiple heads, making them coexist with limited mutual hindrance even in a relatively limited cutting area.

### DISCLOSURE OF THE INVENTION

The aim of the present invention is to provide a cutting apparatus, particularly for hides and the like, that allows to have the smallest possible space occupation of the cutting head on the worktable or cutting area, fully to the advantage of the operator.

Within this aim, an object of the present invention is to provide a cutting apparatus, particularly for hides and the like, in which the constructive simplicity of the movable bridge architecture is combined with an accessibility and visibility of the common placement/cutting area that are typical of the fixed bridge architecture.

Another object of the present invention is to provide a cutting apparatus, particularly for hides and the like, with a worktable having simplified accessibility, which allows to process hides and the like whose dimensions exceed said work area both in front of the work area and laterally to it.

Another object of the present invention is to provide a cutting apparatus, particularly for hides and the like, that can also provide for the use of two cutting heads simultaneously.

Another object of the present invention is to provide a cutting apparatus, particularly for hides and the like, that is highly reliable, relatively simple to provide, and at competitive costs.

This aim and these and other objects that will become better apparent hereinafter are achieved by a cutting apparatus, particularly for hides and the like, comprising a worktable, which defines a cutting area, surmounted by at least one movable transverse bridge, at least one cutting head being provided in order to perform cutting operations, characterized in that said at least one cutting head is supported in a cantilever fashion at a first end of an arm that is adapted to be moved, at a second end thereof, along said movable bridge, transversely with respect to guides for the sliding of said movable bridge, which are arranged laterally with respect to said worktable.

### BRIEF DESCRIPTION OF THE DRAWINGS

Further characteristics and advantages of the invention will become better apparent from the description of preferred but not exclusive embodiments of the apparatus according to the present invention, illustrated by way of non-limiting example in the accompanying drawings, wherein:

FIG. 1 is a perspective view of the apparatus according to the present invention, in a first embodiment;

FIG. 2 is a perspective view of the apparatus according to the present invention, in a second embodiment.

### WAYS OF CARRYING OUT THE INVENTION

With reference to the figures, the apparatus, generally designated by the reference numeral 1, comprises a worktable or placement/cutting area 2, which can be a fixed table or a movable conveyor belt.

At least one cutting head 3 is provided in order to cut the hides arranged on the worktable 2, and such head 3 is appropriately movable along an axis X, which is transverse with respect to the advancement direction of the conveyor belt, if provided, i.e., is movable for example along at least one guide and preferably a pair of guides 4 and 5, which are respectively arranged so as to be superimposed and in the direction of the axis X. The guides 4 and 5 define a bridge that can move along the axis Y, i.e., along the advancement direction of the conveyor belt. The guides 4 and 5 are thus supported by two shoulders 6 and 7, which are mutually opposite and can slide along respective pairs of guides 8 and 9 (and the matching ones on the opposite side), which are arranged parallel to the advancement direction of the conveyor belt and are transverse to the direction of motion of the cutting head 3.

Conveniently, the guides 8 and 9 (and the matching ones on the opposite side) are spaced from the working area or placement/cutting area 2 by an extent 10 that allows the accommodation and passage of any hide or soft material that exceeds the width of the worktable 2.

Conveniently, the cutting head 3 is supported by a longitudinal arm 11, which can slide, as mentioned, along the pair of guides 4 and 5 and is arranged along the direction of motion of the movable bridge.

Moreover, the placement/cutting area 2 is sized so as to protrude forward with respect to the guides 8 and 9 (and to the matching ones on the opposite side), so that, when the movable bridge defined by the pair of guides 4 and 5 and by the pair of shoulders 6 and 7 is in the maximum advancement position, a portion of worktable or placement/cutting area 2 remains which is free from any hindrance caused by the presence of the movable transverse bridge.

Such portion of the placement/cutting area 2 is therefore configured as a cutting area without obstacles on the front and lateral sides, thus allowing to accommodate and process materials, even rigid ones, whose dimensions exceed said work area in each one of these three sides.

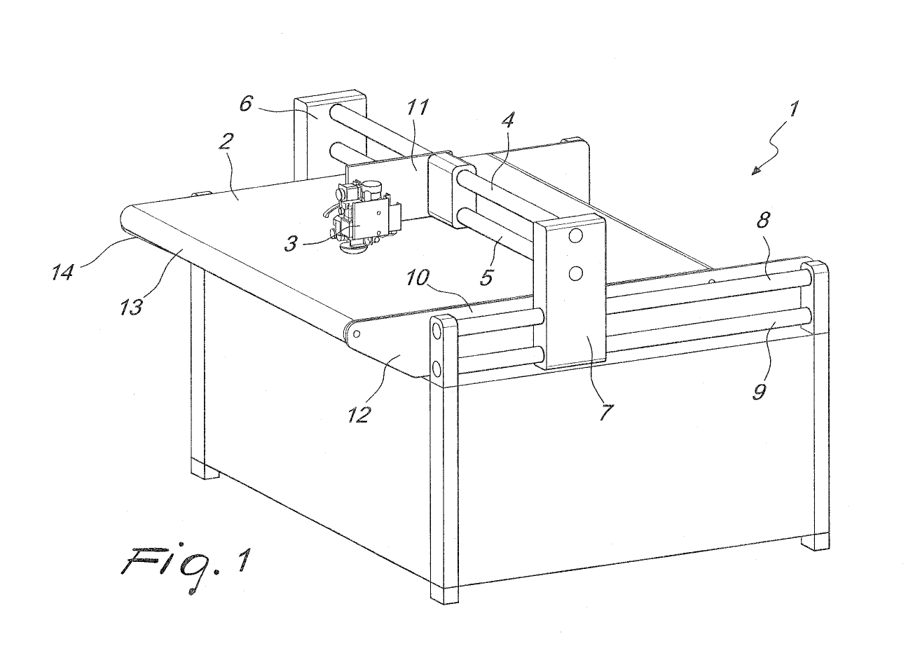

With reference to FIG. 1, the reference numeral 12 designates the extension of the placement/cutting area 2 beyond the length of the sliding guides 8 and 9 (and of the matching ones on the opposite side), so as to define therefore a portion of placement/cutting area 2 that is free on the front side 13 and on the lateral edges, designated by the reference numeral 12 and by the reference numeral 14, respectively.

The front portion of the placement/cutting area 2, defined by the front edge 13 and by the lateral edges 12 and 14, has a depth that is substantially equal to the cantilever of the longitudinal arm 11, so as to allow, with the transverse plane in a maximum advancement stroke position thereof, to work with the cutting head 3 material arranged at the placement/cutting area in front of the guides 8 and 9.

This allows to process rigid material that exceeds the front portion of the placement/cutting area 2 both at the front and laterally.

The apparatus described above allows, with the cutting head 3 that invades the common placement/cutting area 2 only for the width of the longitudinal arm 11 that supports it, while the movable bridge, in its width, remains always substantially more spaced from the operator than the current cutting point, by the depth of the cantilever of the longitudinal arm 11, to combine with the constructive simplicity of the movable bridge architecture the accessibility and visibility of the common placement/cutting area 2 that are typical of the architecture of fixed-bridge cutting apparatuses.

It is further possible to provide also a rear extension of the worktable or placement/cutting area 2, therefore in opposition to the front portion of the placement/cutting area 2 that is free on the three sides, so as to be able to gather the cut pieces.

Substantially, the cantilever arrangement of the cutting head 3, with respect to the movable bridge, facilitates the coexistence of such head with other resources, such as the operator that is dedicated to the placement and collection operations, on the same work area.

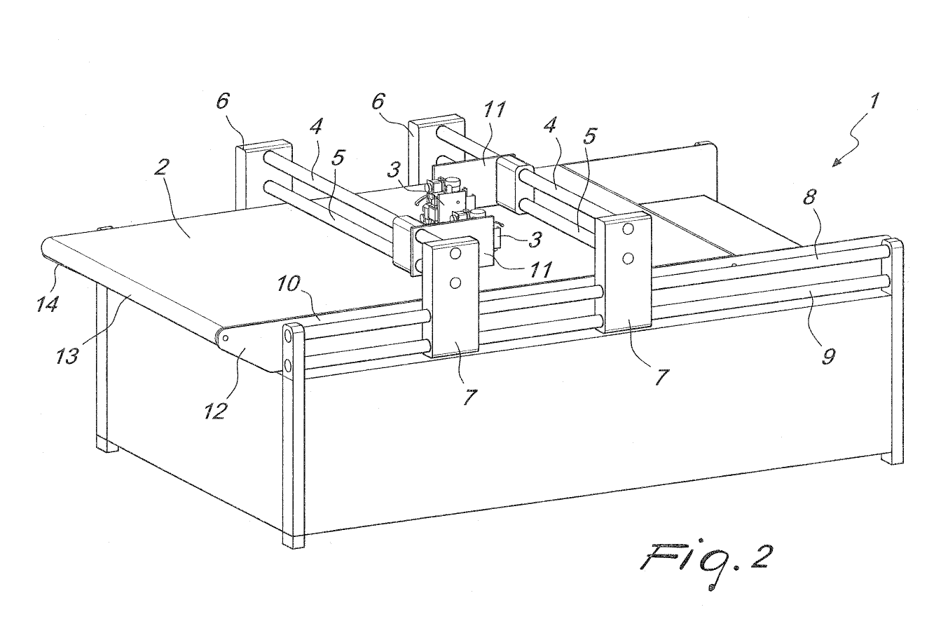

Moreover, the solution proposed above allows, as shown in FIG. 2, to have a second movable bridge that is similar to the first one and faces it, thus allowing two cutting heads to intersect more their respective cutting areas, with respect to two traditional movable bridges, independently of the presence or not of the conveyor belt.

In practice it has been found that the apparatus according to the present invention fully achieves the intended aim and objects.

The apparatus thus conceived is susceptible of numerous modifications and variations, all of which are within the scope of the appended claims. For example, the length of the cantilever arm 11 can be made adjustable mechanically in fixed positions, so as to adapt to work requirements.

Moreover, the worktable, as mentioned, can be a conveyor belt, which is adapted to be moved in combination with the movement of the movable transverse bridge.

The movement of the conveyor belt occurs conveniently along the same direction of movement as the movable transverse bridge.

All the details may further be replaced with other technically equivalent elements.

In practice, the materials used, as well as the contingent shapes and dimensions, may be any according to requirements and to the state of the art.

The disclosures in Italian Patent Application No. MI2009A001535 from which this application claims priority are incorporated herein by reference.

1-9. (canceled)

10. A cutting apparatus, particularly for hides and the like, comprising a worktable which defines a cutting area, surmounted by at least one movable transverse bridge, at least one cutting head being provided in order to perform cutting operations, wherein said at least one cutting head is supported in a cantilever fashion at a first end of an arm that is adapted to be moved, at a second end thereof, along said movable bridge, transversely with respect to guides for the sliding of said movable bridge, which are arranged laterally with respect to said worktable.

11. The cutting apparatus according to claim 10, wherein the sliding guides of said movable transverse bridge are spaced from said worktable.

12. The cutting apparatus according to claim 10, wherein said worktable protrudes with respect to said sliding guides of said movable transverse bridge.

13. The cutting apparatus according to claim 12, wherein a portion of said worktable that protrudes with respect to said sliding guides of said movable transverse bridge is free from obstacles at its front side and at its mutually opposite lateral edges.

14. The cutting apparatus according to claim 10, further comprising an additional movable bridge, which is arranged so as to face said movable bridge and is provided with an additional cutting head, said cutting head and said additional cutting head intersecting the respective cutting areas.

15. The cutting apparatus according to claim 10, wherein said movable bridge is constituted by a pair of lateral shoulders that can slide along pairs of said guides that are mutually opposite with respect to said worktable, said lateral shoulders being mutually connected by a pair of guides that are arranged transversely with respect to said worktable and are adapted to allow the sliding of said movable arm that supports in a cantilever manner said cutting head.

16. The cutting apparatus according to claim 10, wherein said worktable is a conveyor belt.

17. The cutting apparatus according to claim 10, wherein said conveyor belt is adapted to be moved in combination with the movement of said movable transverse bridge.

18. The cutting apparatus according to claim 10, wherein said conveyor belt can move in the same direction of movement as said movable transverse bridge.
